(19) United States
(12) Patent Application Publication
(10) Pub. No.: US 2004/0268124 A1
(43) Pub. Date: Dec. 30, 2004

(54) Systems and methods for creating and maintaining a centralized key store

(75) Inventor: Ram Gopal Lakshmi Narayanan, Woburn, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo, Finland

(21) Appl. No.: 10/608,690

(22) Filed: Jun. 27, 2003

(51) Int. Cl. H04L 9/00

(52) U.S. Cl. 713/164

(57) ABSTRACT

A system, method, security gateway and computer program product are provided for creating and maintaining a centralized key store. The system includes a first security gateway and a second security gateway. The first security gateway is capable of applying a security service associated with an application instance identifier to at least one packet of data to thereby transform the at least one packet of data. In this regard, the first security gateway can apply the security service to the packet based upon at least one security policy and at least one security association. The second security gateway, in turn, is capable of applying the security service associated with the application instance identifier to the transformed packet of data to thereby generate a representation of the packet of data.

### FIELD OF THE INVENTION

The present invention relates generally to providing security to network connections and, more particularly, relates to systems and methods for providing a common layer for common security services and cryptographic keys stored at a central location.

### BACKGROUND OF THE INVENTION

The benefit of using the Internet to obtain access to the wealth of information available online and that portion of the Internet comprising the World Wide Web (WWW) is widely recognized. Traditional ways of accessing the Internet have in the past been performed through stationary access points such as at work, school, or at home. The concept of stationary access points has been at the root of the Internet model from the beginning. By way of example, Internet Protocol (IP) routes packets to their destinations according to their IP addresses. The IP addresses are associated with a fixed physical location much the same way as conventional phone numbers are associated with the physical locations of fixed line phones. This association with the physical location allows IP packets to be routed to their intended destination in an efficient and effective way.

The traditional concept of connectivity has undergone changes caused by the trend toward mobility as witnessed, for example, by the transition to mobile telephony in recent years. Mobile computing is another area that is gaining popularity where benefits can be clearly achieved by allowing users the freedom of carrying out their work irrespective of their location. Furthermore, reliable access to the Internet will enable mobile networking to provide improved productivity for all users by freeing them from the ties that bind us to the office. More and more the trend is moving toward wireless connections that provide even more freedom by allowing access from virtually any location such as on airplanes and in automobiles, for example.

One of the primary concerns with IP content, computing and communication is that of security. The open nature of the Internet inherently exposes transmitted packets to security issues which are compounded by the movement of mobile nodes between different sub-networks. To deal with these issues, an IP security protocol (or simply IPsec) has been developed, such as that specified in Internet Engineering Task Force (IETF) request for comment document RFC 2401, entitled: Security Architecture for the Internet Protocol, the contents of which are hereby incorporated by reference in its entirety. In this regard, IPsec was developed to provide end-to-end security for the payload of packets when transmitting between IP hosts. This is chiefly accomplished by providing the hosts with datagram-level authentication and encryption of packets, typically by using symmetric cryptography that requires the use of the same keys at both ends. A key management protocol such as Internet Key Exchange (IKE) can be used to generate the symmetric keys for use in an IPsec stack.

An IPsec enabled host, or security gateway, maintains a security policy in a Security Policy Database (SPD) populated with a number of selectors, as specified in RFC 2401, for example. The SPD identifies which kind of security is applied for the traffic e.g. an IPsec policy may require that all traffic packets are tunneled with an Encapsulating Security Payload (ESP) to a security gateway with the exception of certain packets which are passed through without IP processing. The example of the security policy described here will be performed and effected on all packets passing through the host node.

The convergence of storage, wireless and mobile networks, and networks such as the Internet has opened new application requirements. Thus far, the growth of the Internet has been driven by end users and has resulted in changes in various technologies, including content, computing and communication. And as will be appreciated, each of these technologies has different security and policy requirements for operation. As a result, multiple security mechanisms are currently required to satisfy the diverse security needs of these technologies, although the security mechanisms all have a common goal, namely to protect the privacy, confidentially and/or integrity of end user's data.

More particularly, although most applications operating over the Internet or within a given computing platform provide one or more security services operating in accordance with common goals, those applications fail to reuse information, such as cryptographic keys, common to those security services. In this regard, irrespective of type of domain (i.e., content, computing or communication) of conventional applications, security services offered by those applications typically implement two functions: security policy and security mechanisms. Security policies are specific to an application domain and vary from user-to-user. For example, IPsec defines policies based on IP headers in a SPD, and cryptographic parameters in a SAD. Similarly, storage-based applications, such as Cryptographic File Storage (CFS), define policies based on user credentials.

As an example of an application performing security services consider a virtual memory manager (VMM) application. In computing and storage, VMM applications are used to swap a portion of the process space to/from memory (this portion of memory oftentimes referred to as a swap disk) when an application performing security services is in use and requests a page fault. Without security services, if the memory, which may be embodied in a hard disk, is stolen, the cryptographic keys used to perform the security services may be retrieved, such as by performing reverse engineering techniques. To avoid exposing the cryptographic keys to such breaches, swap operations may be combined with encryption/decryption functions so that the data stored in the swap disk is secured. As another example, consider a CFS application, which may perform operations similar to VMM applications in either real or non-real time. As can be shown, the policies and parameters for many applications are different, but all provide the same set of services (e.g., secured storage).

To illustrate the drawbacks of applying different security services according to different techniques, consider that security services such as IPsec are tightly coupled to the security policies and security mechanisms applied by the respective security services. With respect to IPsec, for example, the architecture only specifies what fields need to be used as selectors, and what fields need to be stored in the SPD and SAD for IPsec security services. And since IPsec provides security at the IP level of the TCP/IP stack, when a read or write system call is invoked by an application providing IPsec security services, the IPsec layer processing is performed automatically, which restricts application of the information in the SPD and SAD from applications desiring to perform application layer security (confidentiality) and/or network layer security (authenticity).

To summarize the drawbacks of current security services, then, the various security layers currently used by different applications do not reuse common code, thus requiring additional storage space and processing to implement the security services. In this regard, no uniform interface exists to define policies across applications. Further, considering that if more and more applications are developed with varying requirements, the size and complexity of the foot-print of code and security policy functions will become an increasing problem, particularly for resource-limited devices, such as mobile stations.

Techniques have been developed to attempt to create a more uniform use of code for security services, such as Generic Security Service (GSS) API and multicast security. Such techniques are particularly suited for client/server computing, however, each technique has drawbacks. In this regard, although GSS defines generic security services, GSS is closely tied to Kerberos security services, this making GSS suitable for client/server applications, but not suitable for operating system specific (e.g., CFS) security services. Multicast security, on the other hand, is not targeted for code reuse as its protocol for secured client/server communication at different layers does not support flexible selector operations. In general, then, no technique currently exists for providing a unified, centralized key store with flexible selector fields that meets the requirements for computing, content and communication technologies for security services.

### SUMMARY OF THE INVENTION

In light of the foregoing background, embodiments of the present invention provide systems and methods for creating and maintaining a centralized key store. Embodiments of the present invention are capable of providing a common layer for common security services and a key store at a one location, which may be accessed through a security application program interface (API) to different applications providing security services. As such, embodiments of the present invention are capable of increasing reuse of code for security services in a modular fashion, and in a manner easily implemented at communication endpoints. Thus, embodiments of the present invention are capable of facilitating application of security services by applications operating on resource-constrained devices such as mobile stations, as the reuse of code decreases the memory required to store code utilized to perform such services.

According to one aspect of the present invention, a system is provided for creating and maintaining a centralized key store. The system includes a first security gateway and a second security gateway. The first security gateway is capable of applying a security service associated with an application instance identifier to at least one packet of data to thereby transform the at least one packet of data. In this regard, the first security gateway can apply the security service to the packet based upon at least one security policy and at least one security association. The second security gateway, in turn, is capable of applying the security service associated with the application instance identifier to the transformed packet of data to thereby generate a representation of the packet of data. For example, the second security gateway can receive the transformed packet of data from the first security gateway, and thereafter apply the security service to the transformed packet based upon the security associations.

More particularly, the first security gateway can be capable of providing at least one security policy, where each security policy includes an application instance identifier associated with a security service. The first security gateway can also be capable of creating at least one security association based upon the security service associated with the application instance identifier. For example, the first security gateway can be capable of creating the security associations according to an Internet Key Exchange (IKE) technique. Regardless of how the security policies are provided and the security associations are created, by providing the security policies and creating the security associations, the first security gateway is capable of creating a centralized key store including the security policies and the security associations. Further, the first security gateway may be capable of providing the security policies further including at least one selector field having at least one selector value in a format common to a plurality of security service protocols (e.g., IPsec). In such instances, the first security gateway can be capable of applying the security service further based upon the security policies including the selector values.

According to other aspects of the present invention, a method, security gateway and computer program product for creating and maintaining a centralized key store are provided. Therefore, embodiments of the present invention provide systems, methods, security gateways and computer program products for creating and maintaining a centralized key store. Embodiments of the present invention are capable of providing a common layer for common security services and a key store at a one location, which may be accessed through a security application program interface (API) to different applications providing security services. In this regard, embodiments of the present invention may extend the security association database (SAD) and security policy database (SPD) of the IPsec architecture to provide applications with access to the SAD and SPD, such as via the security API. Advantageously, embodiments of the present invention can provide access to the SAD and SPD without changing the IPsec protocol, but by changing, for example, the calling sequence to such databases. By providing access to a centralized key store, embodiments of the present invention are capable of applying security services to different domains, such as computing domains (e.g., operating system swapping), content domains (e.g., CFS) and/or communication domains (e.g., IPsec, TLS, etc.). Therefore, the system and method of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 shows a system for restricting event subscriptions through proxy-based filtering, according to one embodiment of the present invention;

FIG. 2 is a schematic block diagram of a server, which may be representative of a host and/or a security gateway, according to one embodiment of the present invention;

FIG. 3 is a schematic block diagram of a mobile station that may operate as a host and/or a security gateway, according to embodiments of the present invention;

FIG. 4 illustrates a protocol stack and the interaction thereof with a security policy database (SPD) and security association database (SAD), in accordance with one embodiment of a method for creating and maintaining a centralized key store; and

FIGS. 5A and 5B are flow charts illustrating various steps in a method of performing security services for outbound and inbound traffic, in accordance with one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

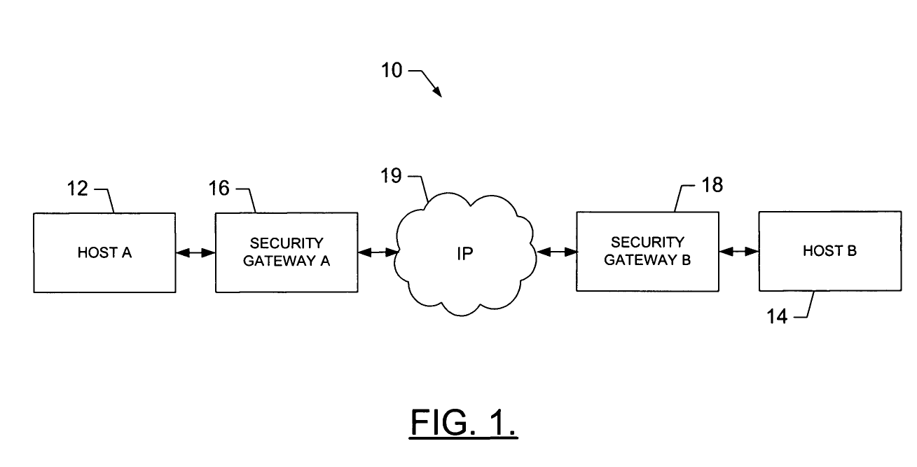

Referring now to FIG. 1, a general system 10 is shown for maintaining a centralized key store, according to embodiments of the present invention. The system generally includes a two end points or hosts, namely a host A 12 and a host B 14. The system further includes an IP communications network 20 through which host A and host B communicate. In accordance with embodiments of the present invention, the system provides an IP security (IPsec) framework, such as that described in Internet Engineering Task Force (IETF) request for comment document RFC 2401, entitled: Security Architecture for the Internet Protocol, the contents of which are hereby incorporated by reference in its entirety. As such, host A and host B are each registered with a corresponding security gateway A 16 and security gateway B 18, respectively.

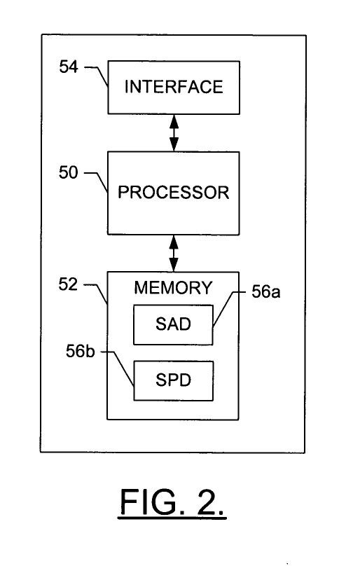

A host, including host A 12 and host B 14, may be any device or entity capable of communicating with other hosts via the IP communications network 20. A security gateway, such as security gateway A 16 and security gateway B 18, may be any device or entity capable of providing security services to a respective host. In this regard, although shown and described herein as comprising separate entities, a host may include a respective co-located security gateway, or vice versa. Referring now to FIG. 2, a block diagram of an entity that may act as a host or a security gateway is shown. The entity acting as either the host and/or gateway generally includes a processor 50 connected to a memory 52 and an interface 54.

The memory 52 typically includes software applications, instructions or the like for the processor to perform steps associated with operation of the respective element in accordance with embodiments of the present invention. For example, the memory may include user or host applications such as a conventional Web browser, a file transfer (e.g., FTP) application, a Telnet application, a peer-to-peer access application, a virtual memory manager (VMM) application or the like. Additionally, the memory may include security applications such as those capable of providing security services in accordance with various protocols, such as IPsec, Kerberos, Cryptographic File Storage (CFS), Secure Sockets Layer/Transport Layer Security (SSL/TLS) or the like.

Further, as a security gateway, the memory 52 may also include a security application programming interface (API) allowing the processor to maintain a centralized key store for one or more of the applications providing security services. In this regard, the memory may also store a security association database (SAD) 56a capable of security associations of the respective host with other hosts, and a security policy database (SPD) 56b capable of storing the security policies that are enforced by the respective security gateway. The SAD and SPD can be configured in accordance with any of a number of different security protocols, but in one advantageous embodiment, the SAD and SPD are configured in accordance with IPsec and operated in conjunction with various IP layer protocols (e.g., Mobile IP), except as described herein.

In accordance with IPsec, the SAD 56a comprises a database for storing security associations protecting outgoing traffic, and for storing security associations protecting incoming traffic. For outgoing traffic, for example, entries of the SAD can be pointed to by entries of the SPD 56b. More particularly, each entry in the SAD may include one, or more particularly a plurality of, the following fields: destination IP address, IPsec protocol (authentication header (AH) or encapsulating security payload(ESP)), and an SPI (security parameters index). Additionally, each entry may include a sequence number counter, a sequence counter overflow, an anti-replay window, mode and/or lifetime fields, as such fields are well known to those skilled in the art. Further, each entry may include cryptographic parameters including encryption and authentication key parameters such as, for example, AH parameters, ESP parameters for authentication, and/or ESP parameters for ciphering, as such fields are also well known to those skilled in the art.

As defined by IPsec, the SPD 56b comprises a database for storing security policies enforced by the security gateway. Like with the SAD 56a, the SPD stores security policies for outgoing traffic and for incoming traffic, typically storing each separately. Generally, the security gateway utilizes the SPD to determine what traffic must be protected, such as by IPsec. Then, when particular traffic must be protected, the SPD defines what security services must be applied, where the actions may define either (a) discard, (b) relay (i.e., relay without applying security services) or (c) IPsec (apply security services). The SPD stores the security policies indexed by selectors that describe the traffic to which respective security policies are to be applied. Each security policy typically defines an action to take (i.e., discard, relay or IPsec), as well as algorithms and protocols to apply when IPsec is specified as the action to be taken. According to IPsec, selectors are typically defined by the following fields: destination IP address, source IP address, name, data sensitivity level, transport layer protocol, and/or source and destination ports, as such fields are well known to those skilled in the art. In addition to, or in lieu of, the preceding IPsec fields, in accordance with embodiments of the present invention, the selectors may be defined by one or more user defined fields, as described below.

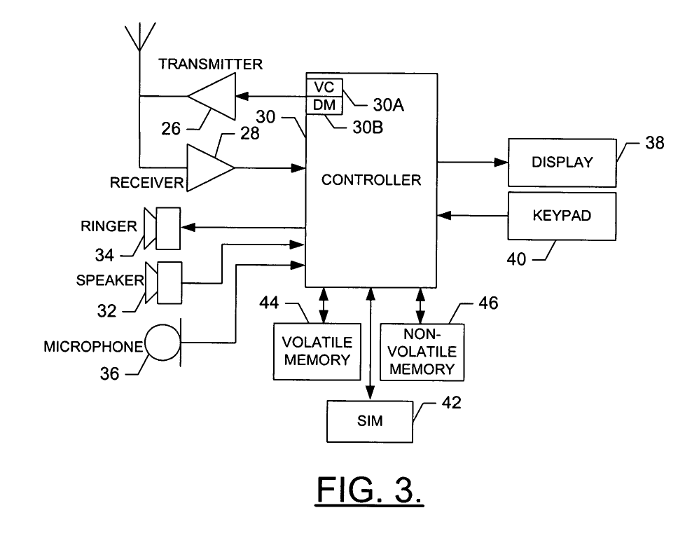

Reference is now drawn to FIG. 3, which illustrates a functional diagram of a mobile station that may act as either a host, such as host A 12 or host B 14, or a security gateway, such as security gateway A 16 or security gateway B 18, according to embodiments of the invention. It should be understood, that the mobile station illustrated and hereinafter described is merely illustrative of one type of mobile station that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

The mobile station includes a transmitter 26, a receiver 28, and a controller 30 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first-generation (1G), second-generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 30 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 30A, and may include an internal data modem (DM) 30B. Further, the controller may include the functionally to operate one or more software applications, which may be stored in memory. For example, the controller may be capable of operating one or more user applications and/or security applications such as those described above.

The mobile station also comprises a user interface including a conventional earphone or speaker 32, a ringer 34, a microphone 36, a display 38, and a user input interface, all of which are coupled to the controller 30. The user input interface, which allows the mobile station to receive data, can comprise any of a number of devices allowing the mobile station to receive data, such as a keypad 40, a touch display (not shown) or other input device. In embodiments including a keypad, the keypad includes the conventional numeric (0-9) and related keys (#, *), and other keys used for operating the mobile station.

The mobile station can also include memory, such as a subscriber identity module (SIM) 42, a removable user identity module (R-UIM) or the like, which typically stores information elements related to a mobile subscriber. In addition to the SIM, the mobile station can include other memory. In this regard, the mobile station can include volatile memory 44, such as volatile Random Access Memory (RAM) including a cache area for the temporary storage of data. The mobile station can also include other non-volatile memory 46, which can be embedded and/or may be removable. The non-volatile memory can additionally or alternatively comprise an EEPROM, flash memory or the like. The memories can store any of a number of pieces of information, and data, used by the mobile station to implement the functions of the mobile station. For example, the memories can store an identifier, such as an international mobile equipment identification (IMEI) code, capable of uniquely identifying the mobile station, such as to a mobile switching center (MSC). Also, for example, the memories can store one or more user applications and/or security applications.

According to embodiments of the present invention a security gateway, such as security gateway A 16 and security gateway B 18, is capable of maintaining a centralized key store for a number of security services. In this regard, security applications operating on the security gateway that may otherwise independently perform security services may be capable of accessing a common key store capable of providing security associations and/or security policies to the respective security applications. More particularly, the security gateway is capable of maintaining the centralized key store, which may be implemented across different domains, such as content (e.g., CFS), computing (e.g., operating system swapping) and communication (e.g., IPsec, TLS) domains.

Embodiments of the present invention will be described in conjunction with extending operation of IPsec to provide a centralized key store for a number of other applications. It should be understood, however, that embodiments of the present invention can extend operation of any of a number of different security applications without departing from the spirit and scope of the present invention. Alternatively, embodiments of the present invention can implement a dedicated protocol capable of performing functions as described herein.

According to one embodiment of the present invention, then, a security gateway, such as security gateway A 16 and security gateway B 18, is capable of storing security policies, such as within the SPD 56b. The security gateway is capable of storing the security policies to include any of a number of different pieces of information, such as information that one or more security applications may require to provide security services. For example, the security policies may be capable of storing information in accordance with protocols such as IPsec, as well as information independent of a particular protocol such as, for example, user age and/or user date of birth.

The SPD can store the security policies in indexed selectors including selector fields, as well as an application instance identifier capable of identifying a security service associated with the selector. For example, if a selector is stored in the SPD for IPsec operation, the application instance can comprise “IPsec.” This field can uniquely identify whether that application is accessing/retrieving the instance in the SPD or SAD database. By including the application instance identifier, the selectors may be stored, and thereafter utilized, by security applications independent of the application domain, whether content, computing, communication or the like. In this regard, if the selectors are associated with identifiers such as sockets, then only communication-based application may be capable of accessing the selectors, thereby restricting access to the selectors from applications such as virtual memory manager (VMM) applications, other local computing applications or the like.

The application instance identifier may also be used as a key during a SPD look-up operation to enhance performance. For example, if an application transmitting packets in accordance with the Stream Control Transmission Protocol (SCTP) desires to apply different security services for different chunks of data, the security services must typically be applied in the application layer, as opposed to the IPsec or TLS layers. To apply the security services in the application layer, the application can communicate with the security API at any given point by passing the appropriate selector fields and application instance identifier to the security API.

The security policies can be stored in any of a number of different formats, but in one embodiment, the security policies are stored in accordance with the TLV (Type Length Value) format. In this regard, the IP Flow Information Export (IPFIX) specification has defined TLV formats for a number of common security protocols, and as such, the TLV format specified by the IPFIX specification can be utilized for selector definitions. For more information on such a TLV format, see IETF Internet Draft <draft-ietf-ipfix-reqs-10.txt>entitled: Requirements for IP Flow Information Export, the contents of which are hereby incorporated by reference in its entirety. In addition to a format such as the TLV format, the security policies can be stored in one or more vendor-specific and/or application-specific formats.

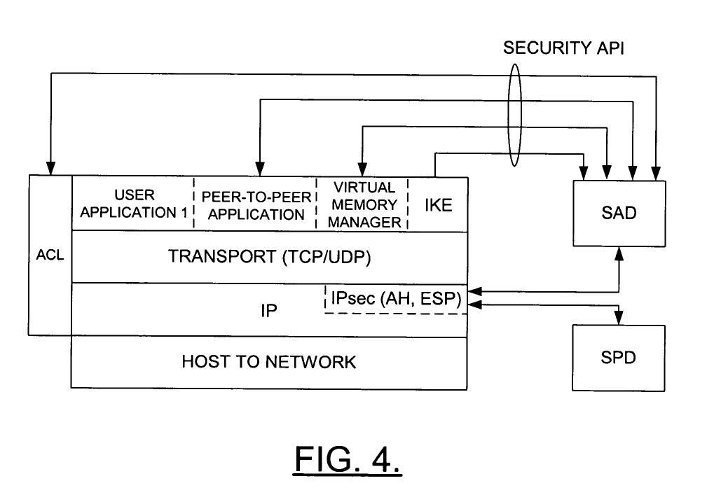

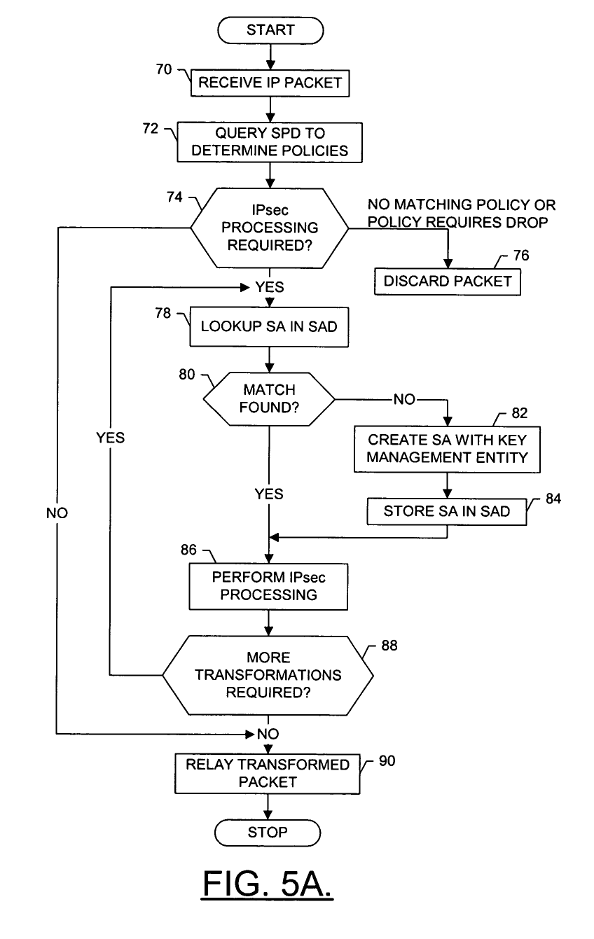

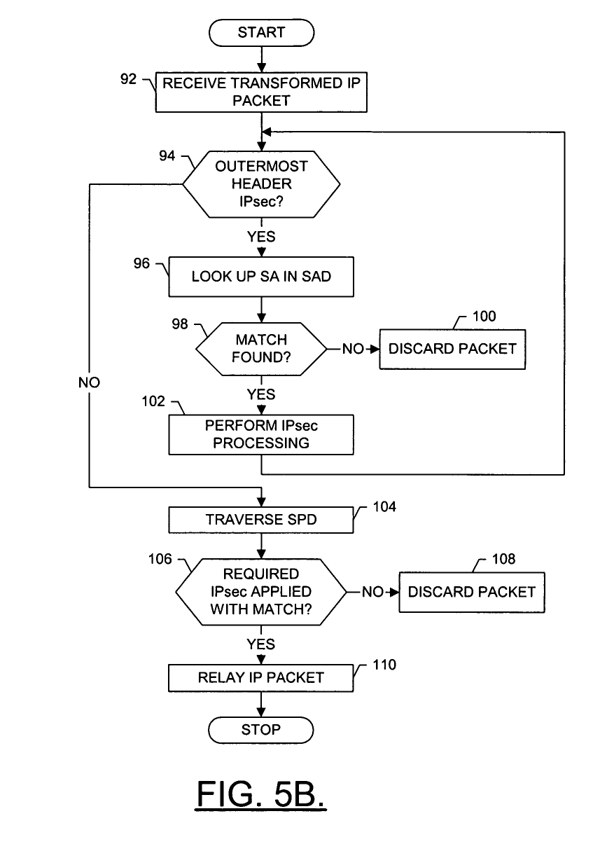

Reference is now drawn to FIG. 4, illustrating a protocol stack and the interaction thereof with the SAD 56a and SPD 56b, in accordance with one embodiment of the present invention; and FIGS. 5A and 5B, which illustrate various steps in a method of creating and thereafter maintaining a centralized key store, such as for outbound and inbound traffic, in accordance with embodiments of the present invention. As shown, the security gateway, such as security gateway A 16, receives a packet of data, as shown in block 70. For example, security gateway A can receive a packet of data from a source application operating on host A 12, such as via a transport protocol such as TCP. In step 72, upon receiving the packet of data, the security gateway looks up required transformations for the packet, such as in the SPD. More particularly, upon receiving the packet of data, the IPsec layer looks up required transformations in the SPD by utilizing the security API operated by the security gateway. For example, the IPsec layer may utilize the security API to lookup a particular selector in the SPD, where the selector may be identified by IPsec layer selector fields, as such are defined by IPsec, and/or one or more user defined selector fields. In addition, the selector may be identified by an application instance identifier (e.g., IPsec) identifying a particular security service.

Once the lookup has occurred, the security gateway determines whether processing according to the security service identified by the application instance identifier (e.g., IPsec) is required, as shown in step 74. If no match is found for the packet, or if the policy requires that the packet be dropped, then the packet is discarded at this point in step 76. When an SPD match that requires security service processing is found, a lookup is performed in the SAD 56a in step 78. As indicated above, the SPD 56b contains policies that specify whether particular packets must be processed. Then, the security associations in the SAD contain the parameters that are needed to perform the operations dictated by the policies in the SPD. For example, the SAD may include security associations defining parameters such as encryption and authentication keys. In accordance with IPsec, for example, the security associations may be identified with an integer identifier referred to as the Security Parameter Index (SPI). This number is included in the IPsec headers (AH and ESP) and may be used to look up the SAD in inbound packet processing where, in outbound processing, a suitable security association is looked up based on the matching security policy.

The security associations, or more particularly the security association parameters, may be created dynamically by a key management protocol such as the Internet Key Exchange (IKE), which is the standard key management protocol in IPsec (although the security association parameters can be created in accordance with any of a number of different security services). Alternatively, the security associations may be created according to any of a number of other techniques, as indicated below. In this regard, a security association is typically always required in order to apply security service transformation. In step 80, a check is made to determine if there is a match in the SAD. When a match is found, for example, the IPsec performs the IPsec transformation as specified in the security policy using the parameters in the security association, as shown in step 86.

When a match in the SAD is not found, a security association (SA) is created between the source application (operating, for example, on host A 12) and a destination application (operating, for example, on host B 14). In this regard, the security association can be created with a key management entity such as the IKE protocol, and based upon the security service identified by the application instance identifier, as shown in step 82. Alternatively, for applications such as VMM applications where the selectors differ from those specified in IPsec, the security associations may be retrieved from memory or other user applications such as, for example, from a SIM 42 (see FIG. 3) or a trusted operating system platform. Also, for applications such as peer-to-peer applications where the destination for the IP packet comprises an Internet service provider (ISP) hosted server or the like, the security associations may be created according to legacy authentication schemes or any other schemes (e.g., passing SIM/IMEI information to the ISP hosted server), where key negotiation may be performed with user-defined selector fields. Further, security associations may be created utilizing TLS with standard selectors, where local memory (e.g., memory 52) may be extended to act as a Lightweight Directory Access Protocol (LDAP) client or the like.

Irrespective of how the security association is created, however, the security association is created based upon the security service identified by the security service identifier (e.g., IPsec). After successfully creating the security association, the security association, or more particularly the security association parameters, can be stored in the SAD 56a for subsequent use. After storing the security association in the SAD, the packet transformation can commence in accordance with the identified security service (e.g., IPsec), as shown in step 86. In this regard, packet transformation can process the packet of data in accordance with the security association and each policy specified in the SPD 56b. More particularly, packet transformation can process the packet in accordance with the authentication header (AH) or encapsulating security payload (ESP) techniques, as such are defined by IPsec and well known to those skilled in the art. Then, in step 88 after performing packet transformation, a check can be made to determine whether more transformations are required, if so, the SAD lookup is repeated in 78. When all the transformations have been applied, in step 90, the transformed packet of data may be relayed to another host, such as host B 14 via IP communications network 20 and security gateway B 18.

According to embodiments of the present invention, after the security association is stored in the SAD 56a, any of a number of different applications can access the security association to perform packet transformations in accordance with the identified security service (e.g., IPsec, CFS, etc.) for the selector in the SPD 56b associated with the respective entry in the SAD 56a. More generally, then, for each security association having an associated selector including an application instance identifier, any application may access the security association through the security API to thereby perform security services in accordance with the security service identified by the application instance identifier. In this regard, as most security services utilize common cryptographic functions, those algorithms common to those security services may be implemented as part of the security API.

Reference is now made to FIG. 5B, which illustrates various steps in a method of maintaining a centralized key store for inbound traffic, in accordance with embodiments of the present invention. As shown, the security gateway, such as security gateway B 18, receives a packet of data transformed according to a security service (e.g., IPsec) identified by an application instance identifier, as shown in step 92. For example, security gateway B can receive a transformed packet of data from a user application operating on host A 12, such as via security gateway A 16 and IP communications network 20. In step 94, the outermost header of the transformed packet is checked for an IPsec header. If the outermost header is not an IPsec header, the processing continues in step 104. If the outermost header is an IPsec header, a security association is looked up in the SAD 56a of the respective security gateway, as shown in step 96. In this regard, a SAD look up is typically always required if the transformation is an IPsec transformation (AH or ESP).

In step 98, a check is made to determine if there is a match between the transformed packet and a security association in the SAD 56a. If a match is not found the packet is discarded, as shown in step 100. When there is a match, the security service identified by the application instance identifier (e.g., IPsec) performs a transformation in step 102 to thereby generate a representation of the original IP packet transformed, as shown in FIG. 5A. In this regard, IPsec can perform the transformation using the security associations and the security gateway keeps track of the order of application of the security associations. In step 94, a check is made for any remaining IPsec headers, and if the transformed packet includes any other IPsec headers, the SAD lookup of step 96 is repeated. If the transformed packet does not include any, or any other, IPsec headers, the SPD 56b of the respective security gateway is traversed in step 104 to determine whether the required transformations have been applied, as shown in step 106. If there is no matching policy, the packet is discarded, as shown in step 108. However, if the there is a match, a check is made to determine whether the SPD entry for the respective packet matches all or part of the applied processing. If the SPD entry matches all of the applied processing, then the packet can be forwarded to its intended destination, such as a user application operating on host B 14.

As will be appreciated by those skilled in the art, the steps of the method of FIG. 5B may be applicable in conventional IPsec processing. According to conventional IPsec processing, the steps of processing inbound transformed packets are performed such that applications cannot perform various of the steps without performing the other steps. In accordance with embodiments of the present invention, however, various of the steps in the method of FIG. 5B may be performed without performing other of the steps because applications may access the SAD 56a and/or SPD 56b, such as via the security API. For example, an application providing security services may be capable of performing specific IPsec functions, such as cryptographic validation, by performing various of the steps of the method of FIG. 5B (e.g., all or portions of steps 96, 98 and/or 102) as independent functions.

Further, for example, consider an application such as a Mobile IP or layer-3 type application, that desires to perform IPsec only for various packets of a plurality of packets of data. According to conventional techniques, if an entry in the SPD 56b specifies that a stream of packets of data be processed in accordance with IPsec, all of the packets must be processed in accordance with IPsec. In contrast, according to embodiments of the present invention, an application providing outbound security services to a stream of packets of data can utilize IPsec headers (AH/ESP headers) within a protocol utilized by the application, or more particularly within the payload of the stream of transformed packets, during outbound processing of the packets of data. In this regard, the application providing outbound security services can specify those packets to be processed in accordance with IPsec. Then, an application providing inbound security services can interpret those headers within the payload to only process those specified packets in the stream in accordance with IPsec.

As will also be appreciated, the security API and the databases (i.e., SAD 56a and/or SPD 56b) can be utilized to perform any of a number of functions in addition to creating security associations such as according to an IKE technique, in accordance with embodiments of the present invention, particularly since, as indicated above, algorithms common to security services may be implemented as part of the security API. For example, applications may utilize the security API to encrypt and/or decrypt data, refresh cryptographic keys stored in the SAD, perform integrity checks, and compute integrity values. Also, for example, the security API can be utilized to create security associations in accordance with techniques other than IKE, as described above. As will be appreciated, then, the security API can be utilized to share code used to perform security services among various applications in a modular manner, while implementing a uniform policy configuration. It should also be noted that the centralized key store can be extended to incorporate firewall functions, as such functions that typically require an access control list (ACL) policy database (see FIG. 4) analogous to the SPD 56b database.

According to one aspect of the present invention, the system of the present invention, such as the security gateway (e.g., security gateway A 16 and/or security gateway B 18), generally operates under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 5A and 5B are flowcharts of methods, systems and program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowcharts support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of creating and maintaining a centralized key store comprising:
providing at least one security policy, wherein each security policy includes an application instance identifier associated with a security service; and
creating at least one security association, wherein the at least one security association is created based upon the security service associated with the application instance identifier to thereby create a centralized key store including the at least one security policy and at least one security association.

2. A method according to claim 1 further comprising:
receiving at least one packet of data; and
applying the security service associated with the application instance identifier to the at least one packet of data to thereby transform the at least one packet of data, wherein the security service is applied to the at least one packet based upon the at least one security policy and the at least one security association.

3. A method according to claim 2 further comprising:
receiving the at least one transformed packet of data; and
applying the security service associated with the application instance identifier to the at least one transformed packet of data to thereby generate a representation of the at least one packet of data, wherein the security service is applied to the transformed at least one packet based upon the at least one security association.

4. A method according to claim 2, wherein providing at least one security policy comprises providing at least one security policy further including at least one selector field having at least one selector value in a format common to a plurality of security service protocols, and wherein applying the security service comprises applying the security service further based upon the at least one security policy including the at least one selector value.

5. A method according to claim 1, wherein creating at least one security association comprises creating at least one security association according to an Internet Key Exchange (IKE) technique.

6. A system for creating and maintaining a centralized key store comprising:
a first security gateway capable of applying a security service associated with an application instance identifier to at least one packet of data to thereby transform the at least one packet of data, wherein the first security gateway is capable of applying the security service to the at least one packet based upon at least one security policy and at least one security association; and
a second security gateway capable of applying the security service associated with the application instance identifier to the at least one transformed packet of data to thereby generate a representation of the at least one packet of data.

7. A system according to claim 6, wherein the first security gateway is capable of providing at least one security policy, wherein each security policy includes an application instance identifier associated with a security service, wherein the first security gateway is also capable of creating at least one security association, and wherein the first security gateway is capable of creating the at least one security association based upon the security service associated with the application instance identifier to thereby create a centralized key store including the at least one security policy and the at least one security association.

8. A system according to claim 7, wherein the first security gateway is capable of providing at least one security policy further including at least one selector field having at least one selector value in a format common to a plurality of security service protocols, and wherein the first security gateway is capable of applying the security service further based upon the at least one security policy including the at least one selector value.

9. A system according to claim 6, wherein the second security gateway is capable of receiving the at least one transformed packet of data from the first security gateway, and thereafter applying the security service to the transformed at least one packet based upon the at least one security association.

10. A system according to claim 6, wherein the first security gateway is capable of creating at least one security association according to an Internet Key Exchange (IKE) technique.

11. A security gateway for creating and maintaining a centralized key store comprising:
a security policy database capable of storing at least one security policy, wherein each security policy includes an application instance identifier associated with a security service;
a security association database capable of storing at least one security association; and
a processor capable of creating at least one security association based upon the security service associated with the application instance identifier to thereby create a centralized key store including the at least one security policy and the at least one security association.

12. A security gateway according to claim 11, wherein the processor is capable of receiving at least one packet of data, and thereafter applying the security service associated with the application instance identifier to the at least one packet of data to thereby transform the at least one packet of data, and wherein the processor is capable of applying the security service to the at least one packet based upon the at least one security policy and the at least one security association.

13. A security gateway according to claim 12, wherein the security policy database is capable of storing at least one security policy further including at least one selector field having at least one selector value in a format common to a plurality of security service protocols, and wherein the processor is capable of applying the security service further based upon the at least one security policy including the at least one selector value.

14. A security gateway according to claim 11, wherein the processor is also capable of receiving at least one transformed packet of data, and thereafter applying the security service associated with the application instance identifier to the at least one transformed packet of data to thereby generate a representation of the at least one packet of data, and wherein the processor is capable of applying the security service to the transformed at least one packet based upon at least one security association.

15. A security gateway according to claim 11, wherein the processor is capable of creating at least one security association according to an Internet Key Exchange (IKE) technique.

16. A computer program product for creating and maintaining a centralized key store, the computer program product comprising a computer-readable storage medium having computer-readable program code portions stored therein, the computer-readable program portions comprising:
a first executable portion for providing at least one security policy, wherein each security policy includes an application instance identifier associated with a security service; and
a second executable portion for creating at least one security association, wherein the at least one security association is created based upon the security service associated with the application instance identifier to thereby create a centralized key store including the at least one security policy and at least one security association.

17. A computer program product according to claim 16 further comprising:
a third executable portion for receiving at least one packet of data; and
a fourth executable portion for applying the security service associated with the application instance identifier to the at least one packet of data to thereby transform the at least one packet of data, wherein the security service is applied to the at least one packet based upon the at least one security policy and the at least one security association.

18. A computer program product according to claim 17, wherein the first executable portion provides at least one security policy further including at least one selector field having at least one selector value in a format common to a plurality of security service protocols, and wherein the fourth executable portion applies the security service further based upon the at least one security policy including the at least one selector value.

19. A computer program product according to claim 16 further comprising:
a third executable portion for receiving at least one transformed packet of data; and
a fourth executable portion for applying the security service associated with the application instance identifier to the at least one transformed packet of data to thereby generate a representation of the at least one packet of data, wherein the security service is applied to the transformed at least one packet based upon the at least one security association.

20. A computer program product according to claim 16, wherein the second executable portion creates at least one security association according to an Internet Key Exchange (IKE) technique.
